(19) United States
(12) Patent Application Publication
(10) Pub. No.: US 2015/0149957 A1
(43) Pub. Date: May 28, 2015

(54) METHOD AND SYSTEM FOR WIRELESSLY CONTROLLING IMAGE DISPLAY

(71) Applicant: Junya ENOMOTO, Tokyo (JP)

(72) Inventor: Junya ENOMOTO, Tokyo (JP)

(21) Appl. No.: 14/591,247

(22) Filed: Jan. 7, 2015

Related U.S. Application Data
(63) Continuation of application No. PCT/JP2013/052283, filed on Jan. 31, 2013.

(30) Foreign Application Priority Data
Dec. 22, 2012 (JP) 2012-280370

(51) Int. Cl. G06F 3/0485; G06F 3/0488

(52) U.S. Cl. CPC G06F 3/0485; G06F 3/0488
USPC 715/784

(57) ABSTRACT

Disclosed is a screen display control method by radio of controlling screen display on an operation target device, by transmitting data based on an operation performed on an operation device to the operation target device through radio communication that comprises extracting touch position coordinates from operation events at intervals of a predetermined time N, the operation events generated by one flick operation on a touch panel of the operation device, and transmitting the extracted touch position coordinates to the operation target device and executing screen scroll display control by the operation target device based on the touch position coordinates received from the operation device at intervals of the predetermined time N. When touch position coordinates are not received at intervals of the predetermined time N, the operation target device predicts the missing touch position coordinates, based on previous received touch position coordinates.

### CROSS REFERENCE TO RELATED APPLICATIONS

This application is a continuation application of International Application No. PCT/JP2013/052283, filed on Jan. 31, 2013, entitled “METHOD AND SYSTEM FOR WIRELESSLY CONTROLLING IMAGE DISPLAY” which claims priority based on Article of Patent Cooperation Treaty from prior Japanese Patent Application No. 2012-280370, filed on Dec. 22, 2012, the entire contents of which are incorporated herein by reference.

### TECHNICAL FIELD

The invention relates to a method of operating screen display on an operation target device by an operation device through radio communication.

### BACKGROUND ART

Japanese Patent Application Publication No. 2011-86232 (Patent Document 1) discloses a technology to operate a liquid crystal TV (operation target device) from a mobile phone (operation device) through a wireless LAN (Paragraph 0035 in Patent Document 1). In this case, in terms of the feeling of a user, it is desirable that an operation performed on the operation device is immediately reflected on an action of the operation target device. If there is a perceivable time lag between the operation on the operation device and the action of the operation target device, the user perceives poor operability.

Meanwhile, along with the recent rapid spread of electronic devices having a touch panel (touch screen) as an input interface, a flick operation can be performed as an operation specific to the touch panel. The flick operation is an operation of sliding a finger, a touch pen or the like on the touch panel, i.e., an operation of sliding the finger or the like that is tapped down (touched down) on the touch panel and then tapping up (touching up) the finger or the like. The flick operation is performed in the case of scrolling the display on the touch panel, and the like.

For example, when the flick operation is performed to scroll the screen displayed on the touch panel in the operation device, a large number of touch events are generated in program processing by the operation device. In the case of performing display control so as to cause the same screen scroll also on the screen of the operation target device based on the touch events on the operation device side, when all the touch events generated in the operation device are transmitted directly to the operation target device, a data amount for communication and information processing is increased, resulting in a delay that can be perceived by a user in the display control on the operation target device side. Moreover, a possibility of data lost during communication is relatively high in a radio communication environment, and such loss may cause a delay in the display control on the operation target device side.

### SUMMARY OF THE INVENTION

An aspect of an embodiment provides a screen display control method by radio of controlling screen display on an operation target device, by transmitting data based on an operation performed on an operation device to the operation target device through radio communication that comprises extracting touch position coordinates from operation events at intervals of a predetermined time N, the operation events generated by one flick operation on a touch panel of the operation device, and transmitting the extracted touch position coordinates to the operation target device and executing screen scroll display control by the operation target device based on the touch position coordinates received from the operation device at intervals of the predetermined time N, wherein when touch position coordinates are not received at intervals of the predetermined time N, the operation target device predicts the missing touch position coordinates, based on previous received touch position coordinates.

Another aspect of an embodiment provides a screen display control system by radio that controls screen display on an operation target device by transmitting data based on an operation performed on an operation device to the operation target device through radio communication that comprises an operation device that extracts touch position coordinates from operation events at intervals of a predetermined time N, the operation events generated by one flick operation performed on a touch panel of the operation device, and transmits the extracted touch position coordinates to an operation target device, and an operation target device that executes screen scroll display control based on the touch position coordinates received from the operation device at intervals of predetermined time N, wherein when touch position coordinates are not received at intervals of the predetermined time N, the operation target device predicts the missing touch position coordinates, based on previous received touch position coordinates.

### BRIEF DESCRIPTION OF THE DRAWINGS

FIG. 1 is a system configuration diagram illustrating an embodiment of the invention.

FIG. 2 is a flowchart of an operation app illustrated in FIG. 1.

FIG. 3 is a flowchart of a display control app illustrated in FIG. 1.

FIG. 4 is an explanatory diagram of operations illustrated in FIGS. 2 and 3.

FIG. 5 is a system configuration diagram illustrating an application example of the embodiment.

FIG. 6 is an explanatory diagram of the system illustrated in FIG. 5.

FIG. 7 is a block configuration diagram of an operation device SP illustrated in FIGS. 5 and 6.

FIG. 8 is a block configuration diagram of an audiovisual device SK illustrated in FIGS. 5 and 6.

### DETAILED DESCRIPTION

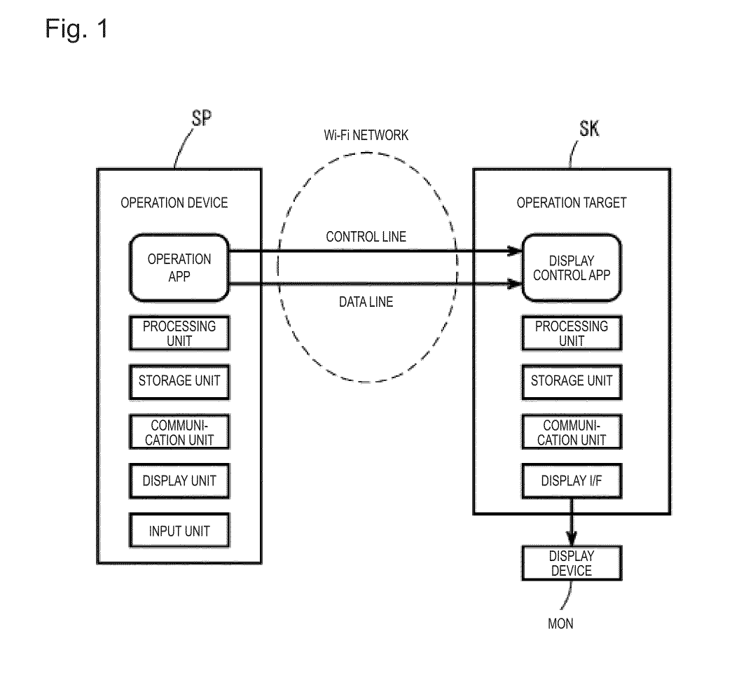

With reference to the drawings, embodiments are described below. In FIG. 1, an operation device SP communicates with an operation target device SK through a Wi-Fi network as a radio network.

The operation device SP includes a processing unit (processor) that executes various kinds of processing by executing programs, a storage unit that writes and reads information data used by the processing unit for the processing, and a communication unit that communicates with the operation target device SK through the radio network. The operation device SP also includes touch panel-type display unit and input unit.

Likewise, the operation target device SK includes a processing unit (processor) that executes various kinds of processing by executing programs, a storage unit that writes and reads information data used by the processing unit for the processing; and a communication unit that communicates with the operation device SP through the radio network. The operation target device SK also includes a display interface (I/F) for connecting to a display device MON such as a liquid crystal TV.

The processing unit in the operation device SP executes an operation application program (operation app) to execute predetermined screen scroll display control for display on a touch panel according to a flick operation inputted from the touch panel, and to transmit data corresponding to the flick operation to the operation target device SK.

On the other hand, the processing unit in the operation target device SK executes a display control app (display control application program) to receive the data corresponding to the flick operation from the operation device SP and execute screen scroll display control, which is equivalent to the screen scroll display control described above in the operation device SP, on display of the display device MON based on the data.

The operation app in the operation device SP and the display control app in the operation target device SK communicate with each other using two communication paths, a control line and a data line, on a Wi-Fi network (IP network). Each of the communication paths is established using a TCP (Transmission Control Protocol) connection or a UDP (User Datagram Protocol) port. Both of the control line and the data line may be established using two TCP connections or may be established using two UDP ports. Alternatively, a transmission speed can be improved by establishing the control line with the TCP and the data line with the UDP.

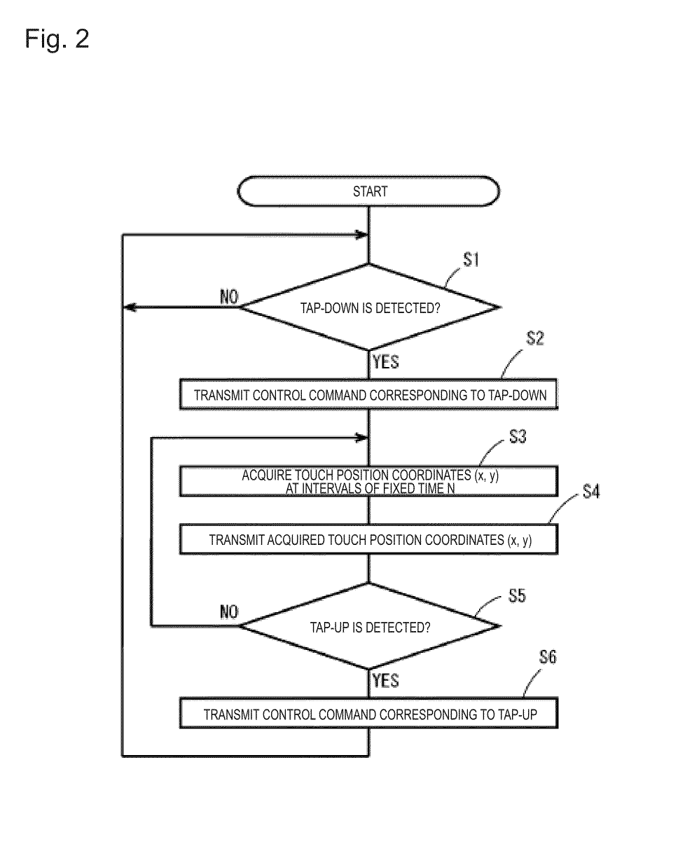

FIG. 2 is a flowchart of the operation app executed in the operation device SP. Once processing of the operation app is started, the processing unit in the operation device SP monitors a tap-down operation on the touch panel, i.e., an operation of touching the touch panel with a finger or the like (S1). When a tap-down is detected, the processing unit transmits a control command corresponding to the tap-down to the display control app in the operation target device SK through the control line (S2). This is in order for the display control app to start display control processing. Subsequently, the processing unit in the operation device SP acquires touch position coordinates (x, y) at intervals of a predetermined time N (S3). The touch position coordinates are coordinates on a screen coordinate system, at which a finger or a pointer such as a touch pen is located on the touch panel. The touch position coordinates change constantly with an operation of sliding a finger or the like.

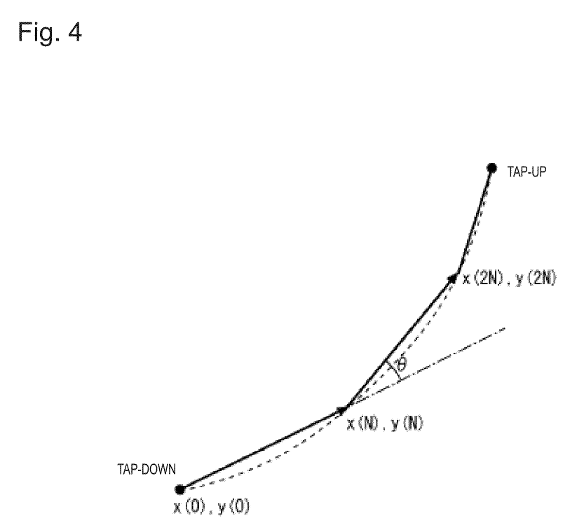

Here, with reference to FIG. 4, description is given of processing of acquiring the touch position coordinates (x, y) at intervals of the predetermined time N. It is assumed that a finger or the like that is tapped down slides along a curve indicated by a dotted line. In this event, assuming that touch position coordinates at a time N are (x (N), y (N)) and touch position coordinates at the point of the tap-down are (x (0), y (0)), the touch position coordinates after a lapse of the first N are (x (N), y (N)) and the touch position coordinates after a lapse of another N are (x (2N), y (2N)). In this way, the touch position coordinates can be acquired at intervals of the predetermined time N. Here, N is a time width that is normally hard for a person to recognize, and is assumed to be a very short time such as about 1 to 300 milliseconds. The finger or the like moves continuously in a flick operation, leading to a large number of touch position coordinates that can be acquired during the time N by the operation. In the above processing, the touch position coordinates are discretely acquired at intervals of the predetermined time N, rather than transmitting all the touch position coordinates to the operation target device SK.

Referring back to FIG. 2, the processing unit in the operation device SP then transmits the touch position coordinates (x, y) acquired in S3 to the display control app in the operation target device SK through the data line (S4). Thereafter, the processing unit in the operation device SP determines whether or not a tap-up operation on the touch panel, i.e., an operation of releasing the finger or the like from the touch panel is performed (S5). When no tap-up is performed, the processing from S3 is repeated since the flick operation is continued. On the other hand, when the tap-up is detected, the processing unit transmits a control command corresponding to the tap-up to the display control app in the operation target device SK through the control line (S6). This is in order for the display control app to stop the display control processing in execution. Then, the processing unit in the operation device SP repeats the processing from S1. These are the operations of the operation device SP according to the operation app in this embodiment.

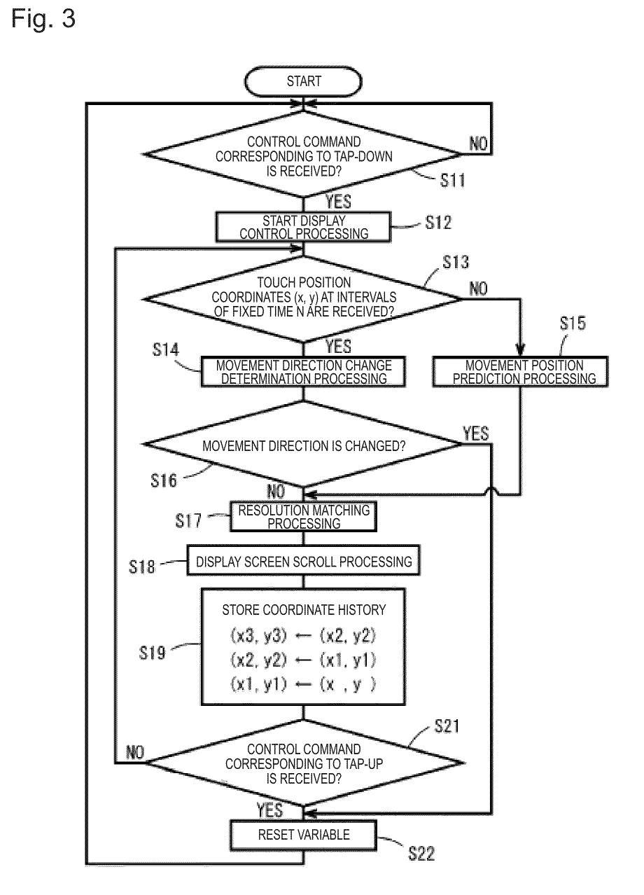

Next, description is given of operations of the operation target device SK executing the display control app. FIG. 3 is a flowchart of the display control app executed by the operation target device SK. Once the processing of the display control app is started, the processing unit in the operation target device SK monitors reception of a control command corresponding to a tap-down from the operation device SP (S11). The control command is received through the control line. Upon receipt of the control command corresponding to the tap-down, the processing unit starts the following display control processing (S12).

The processing unit in the operation target device SK determines whether or not the touch position coordinates (x, y) can be received at intervals of the predetermined time N (S13). The touch position coordinates (x, y) are transmitted in S4 of FIG. 2 by the operation device SP. If there is no data lost (packet loss or packet lost) during radio transmission, the touch position coordinates are received by the operation target device SK through the data line at intervals of the predetermined time N.

When the touch position coordinates (x, y) can be received, the processing unit determines whether or not the movement direction of the finger or the like in the flick operation is changed (S14). As a method of determining whether or not the movement direction of the finger or the like is changed, the following method is conceivable. For example, in FIG. 4, it is assumed that touch position coordinates received this time are (x (2N), y (2N)), the touch position coordinates received this time are (x (2N), y (2N)), touch position coordinates received last time are (x (N), y (N)), and touch position coordinates received before last time are (x (0), y (0)). In this case, when an angle θ formed by a vector (x (2N)−x (N), y (2N)−y (N)) indicating the movement direction this time and a vector (x (N)−x (0), y (N)−y (0)) indicating the movement direction last time exceeds a preset threshold, the movement direction of the finger or the like is determined to be changed. The touch position coordinates received last time and before last time are stored in the storage unit in processing of S19 to be described later.

Here, in this embodiment, the movement direction change determination processing described above is executed on the operation target device SK side. Alternatively, the same processing may be executed by the processing unit in the operation device SP, and a result of determination of whether or not the movement direction is changed may be transmitted from the operation device SP to the operation target device SK. In this case, the determination result is transmitted to the operation target device SK from the operation device SP through the control line, and the operation target device SK may perform determination in S16 based on the received determination result.

On the other hand, when the touch position coordinates (x, y) cannot be received at intervals of the predetermined time N in S13, the processing unit in the operation target device SK executes movement position prediction processing (S15). The movement position prediction processing is processing of predicting the touch position coordinates, which are supposed to be received this time, based on touch position coordinates last time and before last time. In this embodiment, the processing unit in the operation target device SK executes two kinds of prediction processing.

Hereinafter, it is assumed that the touch position coordinates last time are (x1, y1), the touch position coordinates before last time are (x2, y2) and the touch position coordinates three times before are (x3, y3). Here, the respective touch position coordinates are the touch position coordinates received in S13 or the touch position coordinates predicted in S15, and are stored in the storage unit in processing of S19 to be described later.

The processing unit in the operation target device SK executes a first prediction process when the touch position coordinates last time and before last time are stored and a value of the touch position coordinates three times before is not stored in the storage unit. In the first prediction process, coordinates obtained by extending a vector from the touch position coordinates (x1, y1) last time are set as the touch position coordinates (x, y) this time, the vector having the same direction and same distance as those of the vector from the touch position coordinates (x2, y2) before last time to the touch position coordinates (x1, y1) last time. More specifically, the touch position coordinates (x, y) that satisfies (x1−x2, y1−y2)=(x−x1, y−y1) are obtained. In other words, x=2·x1−x2 and y=2·y1−y2 are obtained.

The processing unit in the operation target device SK executes a second prediction process when the touch position coordinates last time, before last time and three times before are stored in the storage unit. In the second prediction process, an acceleration between a vector indicating the movement before last time (movement from (x3, y3) to (x2, y2)) and a vector indicating the movement last time (movement from (x2, y2) to (x1, y1)) is obtained. Then, coordinates obtained by extending a vector having the same direction and same acceleration from the touch position coordinates (x1, y1) last time are set as the touch position coordinates (x, y) this time. More specifically, as to the x-axis, a movement speed from the coordinate x3 three times before to the coordinate x2 before last time is (x2−x3)/N, and a movement speed from the coordinate x2 before last time to the coordinate x1 last time is (x1−x2)/N. Then, the acceleration therebetween is {(x1−x2)−(x2−x3)}/N. In the case of movement at a constant acceleration, {(x−x1)−(x1−x2)}/N={(x1−x2)−(x2−x3)}/N. Therefore, x that satisfies the following is obtained. The same goes for the y-axis.

x=3·x1−3·x2+x3

y=3·y1−3·y2+y3

The processing unit in the operation target device SK executes resolution matching processing (S17) when determining that the movement direction is not changed as the result of the movement direction change determination processing in S14 (S16) or executing the movement position prediction processing in S15. The screen resolution of the touch panel in the operation device SP is different from the screen resolution of the display device MON connected to the operation target device SK. Therefore, in the resolution matching processing, the touch position coordinates (x, y) in the screen resolution of the operation device SP are converted into touch position coordinates (x′, y′) corresponding to the screen resolution of the display device MON connected to the operation target device SK, according to a ratio between the both screen resolutions.

Then, the processing unit in the operation target device SK executes scroll display control on the displayed screen based on the touch position coordinates (x′, y′) converted to match the screen resolution of the display device MON connected to the display I/F (S18). The scroll display control is executed at intervals of the predetermined time N.

Subsequently, the processing unit in the operation target device SK stores the history of the touch position coordinates in the storage unit (S19). The data in the storage unit is updated by setting the touch position coordinates (x2, y2) before last time as the touch position coordinates (x3, y3) three times before, the touch position coordinates (x1, y1) last time as the touch position coordinates (x2, y2) before last time, and the touch position coordinates (x, y) received or predicted this time as the touch position coordinates (x1, y1) last time.

Thereafter, the processing unit in the operation target device SK determines whether or not a control command corresponding to a tap-up is received from the operation device SP (S21). The control command corresponding to the tap-up is transmitted in S6 illustrated in FIG. 2 described above.

Upon receipt of the control command corresponding to the tap-up in S21 or when determining in S16 that the movement direction is changed, the processing unit in the operation target device SK resets a variable such as the history of the touch position coordinates and repeats the processing from S11.

According to this embodiment described above, the touch position coordinates are acquired at intervals of the predetermined time N and transmitted to the operation target device SK rather than transmitting all of (the touch position coordinates that can be acquired from) the operation events generated by a flick operation in the operation device SP. Thus, even in a situation where a communication delay or a packet lost is likely to occur when the operation device SP with a touch panel such as a smartphone emulates the operation contents through radio communication to the operation target device SK without remote control, a delay between the operation and the display control can be suppressed relatively low.

Moreover, even when the operation target device SK cannot receive the touch position coordinates from the operation device SP due to the packet lost or the like, a destination touch position is predicted based on the history of the touch position coordinates. Thus, even in a situation where the communication delay or packet lost is likely to occur, smooth screen display control according to the operation performed by the operation device SP can be realized on the operation target device SK side.

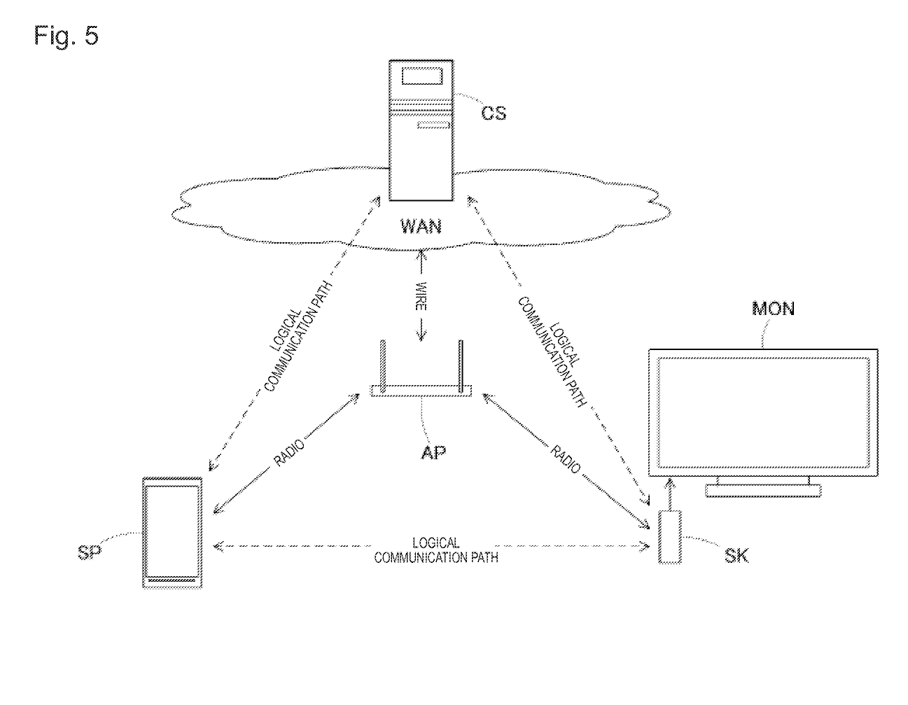

The invention described above can be mounted in a content viewing system to be described next. FIG. 5 is a configuration diagram of the content viewing system. The same components as those in the above embodiment are denoted by the same reference numerals. An audiovisual device SK as the operation target device is connected to a TV monitor MON as the display device. The audiovisual device SK outputs a video signal and an audio signal to the TV monitor MON. The audiovisual device SK performs radio communication compliant with Wi-Fi (Wireless Fidelity) with the operation device SP through an access point AP of a wireless LAN (Local Area Network).

The access point AP is connected by wire to a WAN (Wide Area Network). A content server CS is provided in the WAN, and the operation device SP communicates with the content server CS through the AP. The audiovisual device SK also communicates with the content server CS through the AP.

The communication between the operation device SP and the audiovisual device SK is permitted upon confirmation of the reliability established between the devices, and is performed through a logical communication path. Moreover, the communication between the operation device SP and the content server CS and the communication between the audiovisual device SK and the content server CS are also performed through logical communication paths. The operation device SP controls the operations of the audiovisual device SK through radio communication.

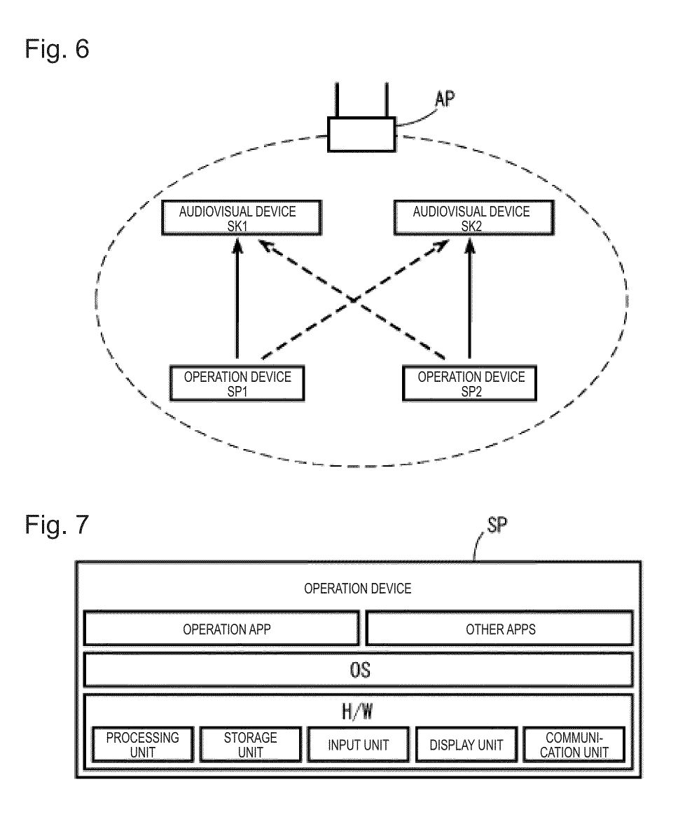

FIG. 5 illustrates one operation device SP and one audiovisual device SK. However, in reality, more than one operation device SP and more than one audiovisual device SK can be located within a communicatable range through the access point AP. In this event, as illustrated in FIG. 6, it is conceivable that an operation device SP1 operates an audiovisual device SK1 or the operation device SP1 operates an audiovisual device SK2. Likewise, an operation device SP2 can operate the audiovisual device SK1 or the operation device SP2 can operate the audiovisual device SK2. In this event, in order to prevent the operation device SP from erroneously operating an audiovisual device other than the audiovisual device SK to be operated, a combination (pair) of the operation device SP and the audiovisual device SK, between which the reliability is established, is registered beforehand.

In this embodiment, the operation device SP is obtained by installing a predetermined application (app) in a smartphone with a Wi-Fi interface. Meanwhile, the audiovisual device SK is housed in a stick-shaped housing of about the same size as a commercially available USB memory. The stick has a width of about 23 mm and a length of about 65 mm. The housing has the Wi-Fi interface installed therein, and also includes a HDMI (High-Definition Multimedia Interface) terminal for video/audio output.

The operation device SP has a configuration illustrated in FIG. 7. In this embodiment, the operation device (smartphone) SP includes constituent components of a computer, executes an OS (Operating System) on various kinds of hardware (H/W), and also executes various application programs (apps) on the OS.

The operation device SP includes, as the hardware: a processing unit configured to realize various functions by executing the programs; and a storage unit configured to store information to be processed by the processing unit. The operation device SP also includes: an input unit used by a user to input information; and a display unit configured to display information to the user. The operation device SP further includes a communication unit for communication with the audiovisual device SK. In this embodiment, the input unit and the display unit are touch panels. The communication unit is a Wi-Fi interface as described above.

On the OS, an operation app and other apps are started. The various operations of the operation device SP are executed by the processing unit executing the operation app.

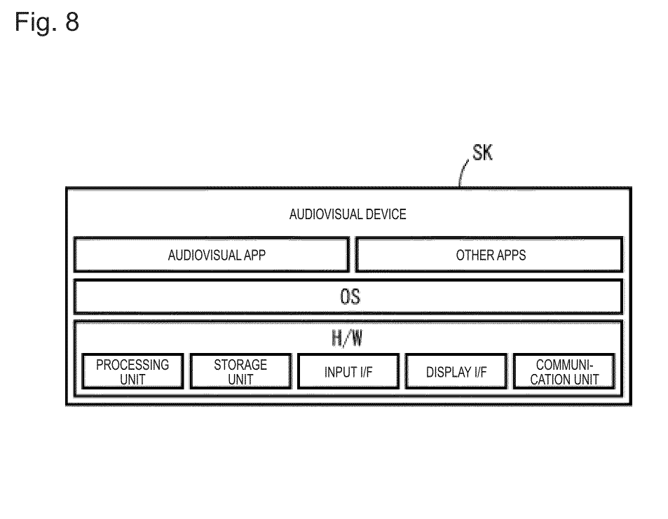

Next, FIG. 8 illustrates a configuration of the audiovisual device SK. In this embodiment, the audiovisual device SK also includes constituent components of a computer, executes an OS (Operating System) on various kinds of hardware (H/W), and also executes various application programs (apps) on the OS.

The audiovisual device SK includes, as the hardware: a processing unit configured to realize various functions by executing the programs; and a storage unit configured to store information to be processed by the processing unit. The audiovisual device SK also includes: an input interface (input I/F) for connecting an input unit; and a display interface (display I/F) for connecting the display device MON. The audiovisual device SK further includes a communication unit for communication with the operation device SP. In this embodiment, the input I/F is a USB terminal, which is provided mainly for the purpose of connecting a USB device during maintenance. Moreover, as described above, the display I/F is a HDMI terminal, and the communication unit is a Wi-Fi interface.

On the OS, a display control app and other apps are started. The various operations of the audiovisual device SK are executed by the processing unit executing the display control audiovisual app and the like.

In the above configuration, the audiovisual device SK performs selection control of contents that can be purchased from the content server CS, purchase control of the selected contents, reproduction control of the purchased contents, and the like. In order to allow the audiovisual device SK to perform such control, the user operates the operation device SP and transmits commands and data from the operation device SP to the audiovisual device SK. The operation includes allowing the operation device SP and the audiovisual device SK to display the same screen and controlling the screen display on the audiovisual device SK to be synchronized with the screen display control that is caused on the operation device SP by a touch panel operation on the operation device SP. In this event, installation of the invention described above enables synchronization of the screen scroll display control.

In this way, the embodiments above provide methods and systems for wirelessly controlling image display that reduce a delay between an operation on the operation device and a display on the operation target device since, when controlling screen display on the operation target device based on an operation event generated in the operation device in a radio communication environment, touch position coordinates are extracted at intervals of a predetermined time N from operation events generated by one flick operation, and transmitted to the operation target device.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A screen display control method by radio of controlling screen display on an operation target device, by transmitting data based on an operation performed on an operation device to the operation target device through radio communication, comprising:
extracting touch position coordinates from operation events at intervals of a predetermined time N, the operation events generated by one flick operation on a touch panel of the operation device, and transmitting the extracted touch position coordinates to the operation target device; and
executing screen scroll display control by the operation target device based on the touch position coordinates received from the operation device at intervals of the predetermined time N, wherein
when touch position coordinates are not received at intervals of the predetermined time N, the operation target device predicts the missing touch position coordinates, based on previous received touch position coordinates.

2. The screen display control method by radio, according to claim 1, wherein
the predicted missing touch position coordinates are obtained by extending a vector from the last received touch position coordinates the same as a vector from the second from the last received touch position coordinates to the last received touch position coordinates.

3. The screen display control method by radio, according to claim 1, wherein
the predicted missing touch position coordinates are obtained by extending a last vector from the last received touch position coordinates with an acceleration, the same as an acceleration between a vector from the third from the last received touch position coordinates to the second from the last received touch position coordinates and the last vector from the second from the last received touch position coordinates to the last received touch position coordinates.

4. A screen display control system by radio that controls screen display on an operation target device by transmitting data based on an operation performed on an operation device to the operation target device through radio communication, comprising:
an operation device that extracts touch position coordinates from operation events at intervals of a predetermined time N, the operation events generated by one flick operation performed on a touch panel of the operation device, and transmits the extracted touch position coordinates to an operation target device; and
an operation target device that executes screen scroll display control based on the touch position coordinates received from the operation device at intervals of predetermined time N, wherein
when touch position coordinates are not received at intervals of the predetermined time N, the operation target device predicts the missing touch position coordinates, based on previous received touch position coordinates.

5. The screen display control system according to claim 4, wherein
the predicted missing touch position coordinates are obtained by extending a vector from the last received touch position coordinates the same as a vector from the second from the last received touch position coordinates to the last received touch position coordinates.

6. The screen display control system according to claim 4, wherein
the predicted missing touch position coordinates are obtained by extending a last vector from the last received touch position coordinates with an acceleration, the same as an acceleration between a vector from the third from the last received touch position coordinates to the second from the last received touch position coordinates and the last vector from the second from the last received touch position coordinates to the last received touch position coordinates.
